(19) United States
(12) Patent Application Publication
(10) Pub. No.: US 2012/0056741 A1
(43) Pub. Date: Mar. 8, 2012

(54) SYSTEM TO TRACK ONE OR MORE INDOOR PERSONS, OUTDOOR PERSONS AND VEHICLES

(76) Inventor: Liping Julia Zhu, San Jose, CA (US)

(21) Appl. No.: 13/226,413

(22) Filed: Sep. 6, 2011

Related U.S. Application Data
(60) Provisional application No. 61/380,638, filed on Sep. 7, 2010.

(51) Int. Cl. G08B 1/08; G06K 7/01

(52) U.S. Cl. 340/539.12; 340/539.13; 340/10.1

(57) ABSTRACT

The present invention is a system to track one or more indoor persons that includes an application server with a first processor, a base station, a plurality of tags, a plurality of medical device sensors that includes a wireless blood pressure sensor, a wireless temperature measurement sensor, or a wireless heart rate sensor with a plurality of predetermined boundary readings that are in communication with the tags, a camera that is in communication with the base station and transmits video or a plurality of picture images to the base station and a mobile device that is in communication with the base station within the system. The system can also be modified to track one or more outdoor persons and one or more new or used vehicles as well.

This application claims priority to U.S. Provisional Application 61/380,638 filed on Sep. 7, 2010, the entire disclosure of which is incorporated by reference.

### TECHNICAL FIELD & BACKGROUND

GPS systems and their popularity have helped persons monitor and track other persons and objects. In case of a family, with some mobile subscription services, caregivers can locate children and other family member's by their mobile device if they desire. However, there are still several significant issues and setbacks. Sometimes the tracked and/or monitored person misplaces their mobile device which also doesn't provide other critical information about the tracked and/or monitored person. For example if a parent's daughter is a new driver the parent probably would like to know not only where she is, but also the condition of the road, the traffic, the weather, and the various conditions of the car. Another example is if a caregiver's elderly grandmother lives alone, a caregiver would probably like to know about her health conditions and other critical events such as if she took her medication(s) during the day.

The present invention generally relates to a system to track indoor persons, outdoor persons and vehicles. More specifically, the invention is a computerized system to track indoor persons, outdoor persons and vehicles.

It is an object of the invention to provide a system to track indoor persons, outdoor persons and vehicles that uses a separate device that is not likely to separate from a user that also acts as an activator for other system capabilities and features.

It is an object of the invention to provide a system to track indoor persons, outdoor persons and vehicles that leverages using a mobile device outdoors as a source of long range communication, while not relying on the mobile device to identify a user.

It is an object of the invention to provide a system to track indoor persons, outdoor persons and vehicles with a local network that utilizes Bluetooth technology in a variety of devices such as medical devices, to collect the condition of a tracked and monitored person as well as a vehicle the tracked or monitored person is driving.

It is an object of the invention to provide a system to track indoor persons, outdoor persons and vehicles that allows the other person to monitor persons such as loved ones either from their computer or their smart phone.

What is really needed is a system to track indoor persons, outdoor persons and vehicles that uses a separate device that is not likely to separate from a user that also acts as an activator for other system capabilities and features that leverages using a mobile device outdoors as a source of long range communication, while not relying on the mobile device to identify a user that utilizes Bluetooth technology in a variety of devices such as medical devices, to collect the condition of a tracked and monitored person as well as a vehicle the tracked or monitored person is driving that allows the other person to monitor persons such as loved ones either from a computer or a smart phone.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of an indoor system of a system to track a plurality of indoor persons, a plurality of outdoor persons and a plurality of vehicles, in accordance with one embodiment of the present invention.

FIG. 2 illustrates a system overview of an outdoor system of a system to track a plurality of indoor persons, a plurality of outdoor persons and a plurality of vehicles, in accordance with one embodiment of the present invention.

FIG. 3A illustrates a system overview of a new vehicle system of a system to track a plurality of indoor persons, in accordance with one embodiment of the present invention.

FIG. 3B illustrates a system overview of an old vehicle system of a system to track a plurality of indoor persons, in accordance with one embodiment of the present invention.

FIG. 4 illustrates a block diagram of a tag of a system to track a plurality of indoor persons, in accordance with one embodiment of the present invention.

FIG. 5 illustrates a block diagram of a base station of a system to track a plurality of indoor persons, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

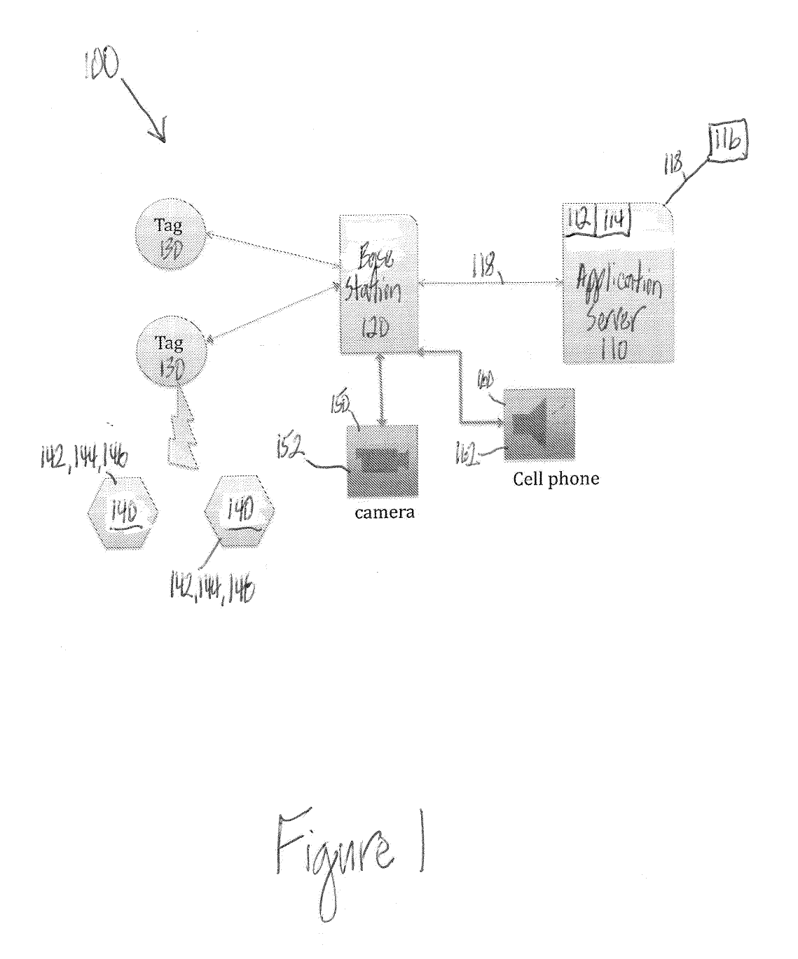

FIG. 1 illustrates a system overview of an indoor system 100 of a system to track a plurality of indoor persons, a plurality of outdoor persons and a plurality of vehicles, in accordance with one embodiment of the present invention.

The indoor system 100 includes an application server 110, a base station 120, a plurality of tags 130, a plurality of sensors 140, a camera 150 and a mobile device 160. The application server 110 includes a processor 112 to process the activities of the components of the indoor system 100 and a communications system 114 to communicate with other systems 116 over a communications network 118 such as the Internet or other suitable communications network. One or more authorized users can view any information from the components of the indoor system 100. The application server 110 can also send any suitable message to any authorized users via a text message or an e-mail. The base station 120 is in communication with the components of the indoor system 110 and transmits information from the components to the application server 110 over the communications network 118. The tags 130 are in communication with each other and the base station 120. The tags 130 can also be a bracelet, a watch, a decorative piece of jewelry or other suitable tag. The sensors 140 can be a wireless blood pressure sensor 142, a wireless temperature measurement sensor 144, a wireless heart rate sensor 146 or any other suitable type of medical device sensor. The sensors 140 can transmit information from the medical device sensors to the tags 130. The sensors 140 are provided with one or more predetermined boundaries readings 142. The camera 150 is in communication with the base station 120 and transmits video or a plurality of picture images 152 to the base station 120 in the indoor area being protected by the indoor system 100. The camera 150 can also be activated when requested by an authorized user. The mobile device 160 is in communication with the base station 120 in the indoor area being protected by the indoor system 100. The mobile device 160 receives an alarm signal 162 from the sensors 140 when the predetermined boundaries readings 142 are exceeded.

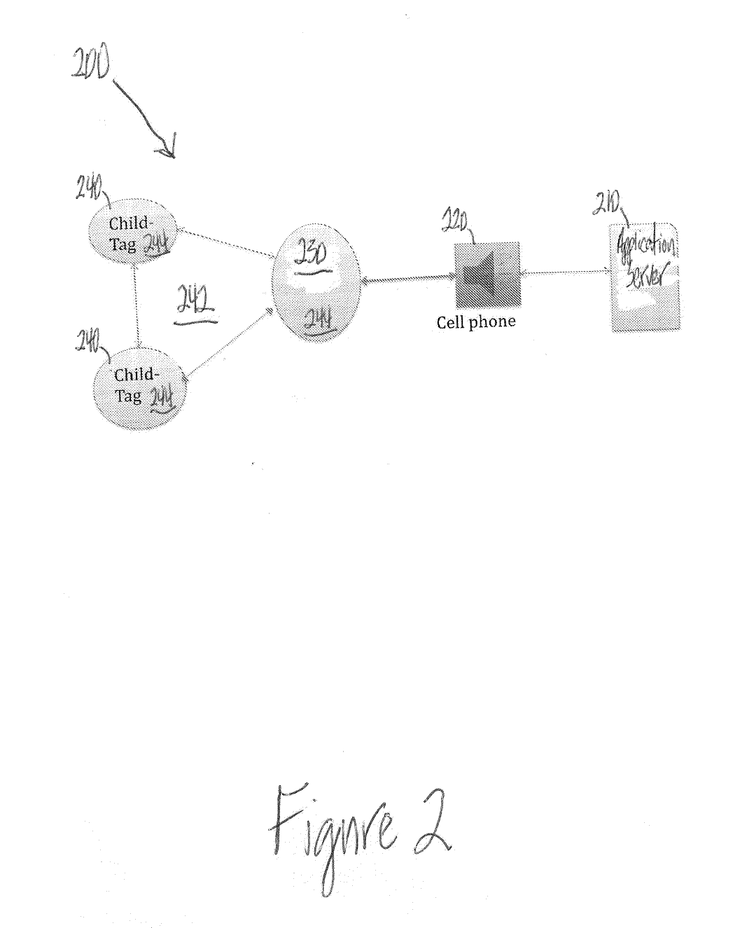

FIG. 2 illustrates a system overview of an outdoor system 200 of a system to track a plurality of indoor persons, a plurality of outdoor persons and a plurality of vehicles, in accordance with one embodiment of the present invention.

The outdoor system 200 includes an application server 210, a mobile device 220, one or more parental tags 230 and one or more children's tags 240. The application server 210 is the same application server with the same features described and illustrated in FIG. 1 and its description. The mobile device 220 is the same mobile device with the same features described and illustrated in FIG. 1 and its description. The parental tags 230 are worn by one or more parents and are in communication with the mobile device 220. The children's tags 240 can communicate with each other via a mesh network 242 or other suitable network and are in communication with the parental tags 230. When a predetermined distance between the parental tags 230 and children's tags 240 is exceeded, an alarm 244 will be activated in the parental tags 230 and the children's tags 240. The children's tags 240 can also generate and transmitted location information 244 to the application server 210 via the parental tag 230 to the mobile device 220.

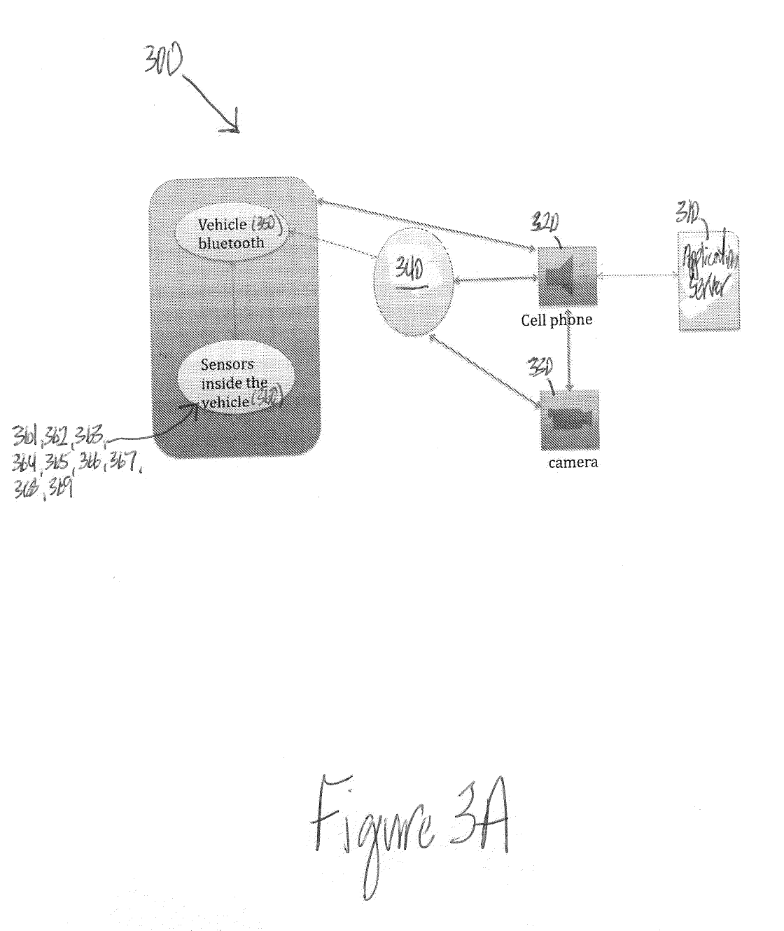

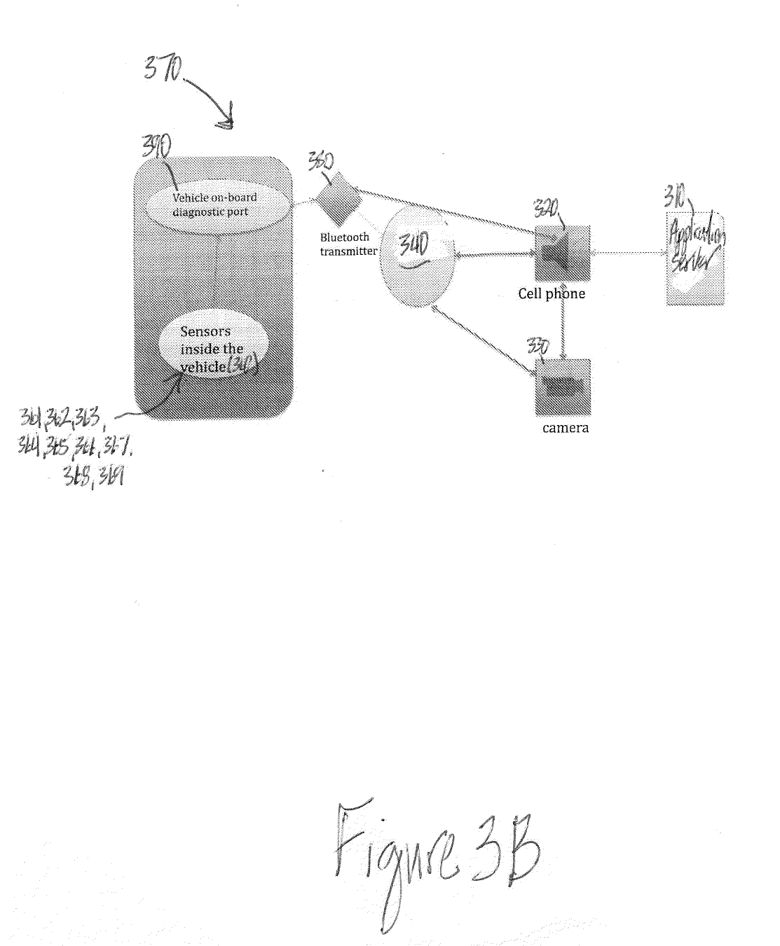

FIG. 3A illustrates a system overview of a new vehicle system 300 of a system to track a plurality of indoor persons, in accordance with one embodiment of the present invention.

The new vehicle system 300 includes an application server 310, a mobile device 320, a camera 330, a driver's tag 340, a vehicle Bluetooth system 350 and a plurality of sensors 360. The application server 310 is the same application server with the same features described and illustrated in FIG. 1 and its description. The mobile device 320 is the same mobile device with the same features described and illustrated in FIG. 1 and its description. The camera 330 is the same camera with the same features described and illustrated in FIG. 1 and its description. The driver's tag 340 is a tag worn by the driver of the vehicle. The vehicle Bluetooth system 350 is provided in the vehicle before the new vehicle system 300 is installed in the new vehicle and is in communication with the driver's tag 340 or the mobile device 320. The sensors 360 are disposed within the vehicle and include brake sensors 361, suspension sensors 362, oil level and other fluid level sensors 363, steering system sensors 364, air conditioning sensors 365, engine sensors 366, lights and exhaust system sensors 367, tire pressure sensors 368, coolant sensors 369 and other suitable sensors. The new vehicle system 300 also provides other relevant information to a user such as GPS location, speed and a weather report with driving and road conditions. The new vehicle system 300 can also be in communication with and transmit information such an alarm or distress signal with an integrated vehicle communication module such as the On-Star System made by General Motors Corporation that will enable a user to make emergency calls and be in communication with an On-Star team if needed or desired.

FIG. 3B illustrates a system overview of an old vehicle system 370 of a system to track a plurality of indoor persons, in accordance with one embodiment of the present invention.

The old vehicle system 370 includes the same application server 310, mobile device 320, camera 330, driver's tag 340 and plurality of sensors 360 with the same features described and illustrated in FIG. 1 and its description. The old vehicle system 370 also includes an external Bluetooth transmitter 380 and a vehicle diagnostic port 390. The external Bluetooth transmitter 380 is external to the vehicle and is designed to be provided for older vehicles without a built-in vehicle Bluetooth system. The vehicle diagnostic port 390 receives and provides the external Bluetooth transmitter 380 with the information detected by the sensors 360 previously described and illustrated in FIG. 3A and its description.

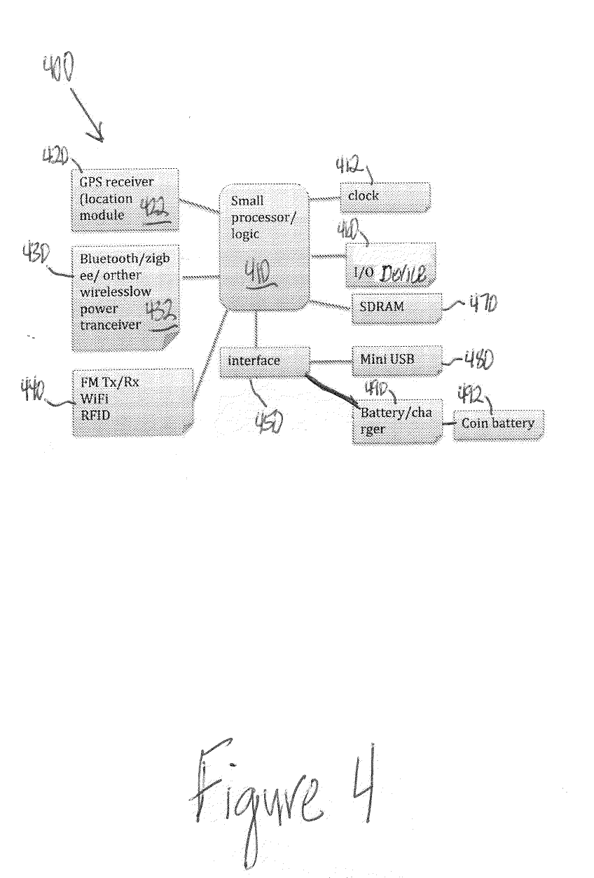

FIG. 4 illustrates a block diagram of a tag 400 of a system to track a plurality of indoor persons, in accordance with one embodiment of the present invention.

The tag 400 is the same tag with the same features described and illustrated in FIG. 1 and its description. The tag 400 can also be a bracelet, a watch, a decorative piece of jewelry or other suitable tag. The tag 400 includes a processor 410, a location module 420, a wireless power transceiver 430, a communications protocol 440, an interface 450, an input and output port 460, SDRAM memory 470, a mini USB port 480 and a battery or charger 490.

The processor 410 utilizes a relatively low cost and high quality chip that is suitable for use over a short distance with the other components of the tag 400. The processor 410 also powers and provides a clock 412 to the tag 400 and can be any suitable clock. The location module 420 is typically a GPS receiver 422 although other suitable location modules can be utilized with the tag 400. The wireless power transceiver 430 is typically a Bluetooth transceiver 432 since the tag to tag communication distances are relatively short (up to 10 meters) and it is desired to maximize battery life and leverage the relatively low power Bluetooth technology. Information transmitted between the tags 400 include discovery of other Bluetooth devices with known IDs, time sharing for multiple devices that replaces a true mesh protocol if needed, information exchange such as payload data, IDs, GPS location, a plurality of alerts and sensor value pairs. The communications protocol 440 can include GPRS, CDMA, 802.1x, zigbee, RFID as well as Bluetooth or other suitable wireless protocols. The interface 450 is an interface that can receive a power source such as a battery, a charger or other suitable power source. Input or output port 460 provides an input and output port to the processor 410. The SDRAM 470 is typically utilized as memory for the tag 400 although other suitable types of memory can also be utilized. The mini USB port 480 is provided to accommodate a mini USB port device 480 or other suitable device. The battery or charger 490 is typically a coin-sized battery 492 that can be any suitable type of coin-sized battery 492 although other suitable batteries can be utilized with the tag 400 as well.

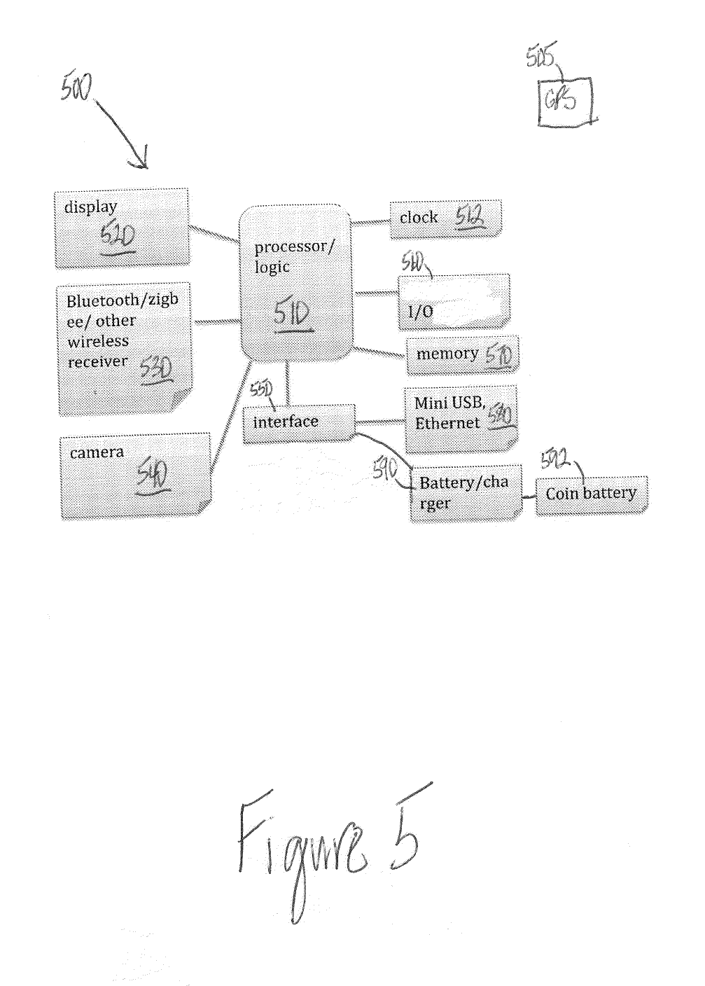

FIG. 5 illustrates a block diagram of a base station 500 of a system to track a plurality of indoor persons, in accordance with one embodiment of the present invention. The base station 500 is utilized as a gateway for indoor tracking where a GPS system 505 may not be operable. The base station 500 can also provide a connection to other wireless home devices such as a Bluetooth camera or medical devices that can also be utilized in combination with the base station 500.

The base station 500 includes a processor 510, a display 520, a wireless power transceiver 530, a camera 540, an interface 550, an input and output port 560, a memory device 570, a mini USB Ethernet 580 and a battery or charger 590. The processor 510 is a relatively larger processor than the processor 410 in the tag 400 that utilizes a relatively low cost and high quality chip that is suitable for use over a short distance with the other components of the base station 500. The processor 510 also powers and provides a clock 512 to the base station 500 that can be any suitable clock. The display 520 can be any suitable type of display such as an LCD display, an analog display, a digital display or other suitable type of display. The power transceiver 530 is typically a Bluetooth transceiver 532 that includes a Wi-Fi connection 534 to accommodate a computer network, an alarm module 536 and a RTLS 538 with a predetermined range within approximately 3.0 meters. The camera 540 is the same camera with the same features described and illustrated in FIG. 1 and its description. The interface 550 is an interface that can receive a power source such as a battery, a charger or other suitable power source. The input or output port 560 provides an input and output port to the processor 510. The memory 570 can be any type of suitable memory that can accommodate the base station 500. The mini USB and Ethernet port 580 can accommodate any suitable USB device or Ethernet related device that can be utilized with the base station 500. The battery or charger 590 is typically a coin-sized battery 592 that can be any suitable type of coin-sized battery 592 although other suitable batteries can be utilized with the base station 500 as well.

### Example #1

Rose Addle son is 70 years old. She is generally healthy. She has high blood pressure, but the blood pressure medicine she is taking is keeping her blood pressure under control. She loves her independence and lives by herself. After a weekend with her children visiting her, she became tired and felt a little lightheaded. She reached to her high blood pressure medicine, but mistakenly got a vitamin bottle instead. She inadvertently took a vitamin from the vitamin bottle instead of taking a pill from the blood pressure medicine and without realizing her mistake and went into her living room. A few hours later, her Blood pressure went up and she fell on the floor.

If Mrs. Addle son was utilizing the system to track a plurality of indoor persons, a plurality of outdoor persons and a plurality of vehicles, as she got the wrong medicine, her watch would have beeped. She would have looked at her watch and would have realized her mistake, would have taken the correct blood pressure medication would have went through her day as planned.

### Example #2

Little Johnny is 5 years old and attends a half-day kindergarten. In the afternoon, his nanny picks him up and they have lunch at home. After lunch, they go down to a little park near his house. It is a gated community with lots of other children like him. His nanny was also very happy to have a social hour with the other nannies in the neighborhood. As his nanny chats with the other nannies, Johnny heard an ice cream car jingling outside and ran out to chase after the cart. No one noticed Johnny was gone until 20 minutes later and Johnny's nanny panicked that Johnny was nowhere to be found.

If Johnny's nanny was utilizing the system to track a plurality of indoor persons, a plurality of outdoor persons and a plurality of vehicles, as Johnny Ran towards the ice cream car, the tag or bracelet that Johnny would be wearing would have alerted the nanny and perhaps even Johnny's parents that Johnny is out of a safety zone. With the system, the nanny's watch would have beeped and she would have tended to Johnny as he was running to the ice cream car. The nanny would have reset the alarm and would have given Johnny's parents a quick update to let them know that Johnny is within a safety zone and everyone involved would go back to their work.

### Example #3

Liz is a 15 year old girl who just got her driver's license a few months ago. She is getting more comfortable with her driving ability and went driving to visit her grandmother on the other side of the town that they live in. It suddenly starts pouring rain but it is only a short 15 minute drive to her grandmother's house and Liz decides to drive to her grandmother's house anyway. Halfway to her grandmother's house, she drives across an intersection, and suddenly a truck turned into her lane right in front of her. She pushed her brake down, and the car started sliding. She panicked and tried to swerve the car into the left lane. But another car was there and she tried to swerve back and drove right into some trees on the other side of the lane. Although the car was damaged, fortunately, no one was seriously injured.

If Liz was utilizing the system to track a plurality of indoor persons, a plurality of outdoor persons and a plurality of vehicles, as Liz drives to her grandma's, her tag or bracelet would have activated the Bluetooth systems in the car and the camera and her mobile device's driving mode. Beforehand, Liz's mother was a little worried about Liz since it was raining so hard. So Liz's mother turned on the virtual driver program in Liz's car from her living room computer. Liz's mom can see the road conditions just like Liz through the camera. She can also see all the parameters of the car from her dashboard on the computer. When Liz saw the car, she yelled “Mom help”. Liz's voice was transmitted to her mother's computer and Liz pushed her brake and the car starts sliding. Liz's mother sees this and immediately talked Liz through how to ease the brake and navigate through a potential car accident.

Elderly people appreciate freedom and independence. However, they do have special needs as they are aging. Staying alone in a house can be dangerous at times. Sometime when an elderly person falls, days would pass before anyone finds out. They also frequently take the wrong medicines, or simply could not get to the hospital when things happen. The system actively monitors the elderly's vital health signals such as heart rate, blood pressure and medicine taken. It sends a signal to a data center where the family and a health care professional can check on the elderly person frequently from the web. When certain thresholds are triggered such as vital signs, alerts and/or alarms are sent to pre-set family members or a caretaker. The system can also route phone calls to the nearest fire/police department in case of emergencies.

As the children learn to walk, their world becomes bigger. Without realizing where they are, frequently children could wander out of the gates of their daycare or leave out of a caregiver's sight in a crowded shopping mall. It can put the panicked parents or caretaker in a desperate situation. Worse still, people do not realize their children are missing many times until they are in a potential dangerous situation. The system allows parents or a caretaker to monitor's children's′ location on a computer or a mobile device. When children wander out of a predefined area, alerts/alarms are immediately sent to the caretaker or parents. When in a public place, the parent's tag and their children's tags are linked and in communication with each other. The parents can set up a safe distance for the children to be within which can also be applied to school outings or a school environment. A teacher's tag or band and the children's band are linked. The teacher can receive an alert on their mobile device/PDA when a child is out of the range set by the system.

The driving nanny system can be used by parents or family. They can be virtual co-pilots with the driver. They can monitor how well the driver is driving and determine such factors as speed and change of direction, and they can monitor the car's general condition such as engine temperature, oil level, accelerator position etc. This same system can also be used by a car dealership to remotely monitor's a car's condition and provide preventive maintenance care. For example, a car dealership can monitor a car's oil-life, engine temperature and tire pressure. After a certain amount of usage, or when certain parameters are approaching the preset threshold, the dealership can call the owner to schedule maintenance.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An indoor system to track one or more indoor persons, comprising:
an application server that includes a first processor to process a plurality of activities from said one or more indoor persons and a communications system to communicate with one or more exterior systems over said communications network;
a base station with a second processor, a display, a first wireless power transceiver, a first interface, a first input and output port, a memory device, a mini USB and Ethernet port and a first battery or a charger that is in communication with said application server;
a plurality of tags that include a third processor, a first GPS module, a second wireless power transceiver, a communications protocol, a second interface, a second input and output port, SDRAM memory, a mini USB port and a second battery or a charger that are in communication with said base station;
a plurality of sensors that includes a wireless blood pressure sensor, a wireless temperature measurement sensor, or a wireless heart rate sensor with a plurality of predetermined boundary readings that is in communication with said tags;
a camera that is in communication with said base station and transmits video or a plurality of picture images to said base station; and
a mobile device that is in communication with said base station within said indoor system.

2. The system according to claim 1, wherein said communications network is the Internet.

3. The system according to claim 1, wherein said first wireless transceiver and said second wireless transceiver is a Bluetooth transceiver.

4. The system according to claim 1, wherein said first battery or charger and said second battery or charger are a coin battery.

5. The system according to claim 1, wherein said tags are selected from the group that consists essential of any combination of one or more bracelets, one or more watches or one or more decorative pieces of jewelry.

6. The system according to claim 1, wherein said mobile device receives an alarm signal from said sensors when said predetermined boundary readings are exceeded.

7. An outdoor system to track one or more outdoor persons, comprising:
an application server that includes a first processor to process a plurality of activities from said one or more outdoor persons and a communications system to communicate with one or more exterior systems over said communications network;
a mobile device that is in communication with said application server within said outdoor system;
one or more parental tags that include a first processor, a first GPS module, a first wireless power transceiver, a first communications protocol, a first interface, a first input and output port, a first SDRAM memory, a first mini USB port and a first battery or a charger that are worn by one or more parents and are in communication with said mobile device; and
one or more children's tags that include a second processor, a second GPS module, a second wireless power transceiver, a second communications protocol, a second interface, a second input and output port, a second SDRAM memory, a second mini USB port and a second battery or a charger that are in communication via a mesh network with other said children's tags and said parental tags with a predetermined distance between said parental tags and said children's tags.

8. The system according to claim 7, wherein said communications network is the Internet.

9. The system according to claim 7, wherein said first wireless transceiver and said second wireless transceiver is a Bluetooth transceiver.

10. The system according to claim 7, wherein said first battery or charger and said second battery or charger is a coin battery.

11. The system according to claim 7, wherein said tags that are selected from the group that consists essential of any combination of one or more bracelets, one or more watches or one or more decorative pieces of jewelry.

12. The system according to claim 7, wherein said predetermined distance between said parental tags and said children's tags is exceeded, and an alarm is activated in said parental tags and said children's tags.

13. The system according to claim 7, wherein said children's tags generate and transmit location information to said application server via said parental tag to said mobile device.

14. A system to track one or more vehicles, comprising:
an application server that includes a first processor to process a plurality of activities from said one or more persons with said vehicles and a communications system to communicate with one or more exterior systems over said communications network;
a mobile device that is in communication with said application server exterior to said vehicle;
a camera that is in communication with said mobile device and transmits video or a plurality of picture images to said base station;
a driver's tag that includes a second processor, a GPS module, a first wireless power transceiver, a first communications protocol, a first interface, a first input and output port, a first SDRAM memory, a first mini USB port and a first battery or a charger that are worn by one or more parents and are in communication with said mobile device;
a vehicle Bluetooth system integral to and provided within said vehicle in communication with said driver's tag and said mobile device; and
a plurality of sensors that is disposed within said vehicle that are in communication with said drivers tag and said mobile device.

15. The system according to claim 14, wherein said communications network is the Internet.

16. The system according to claim 14, wherein said sensors include one or more brake sensors, one or more suspension sensors, one or more oil level and other fluid level sensors, one or more steering system sensors, one or more air conditioning sensors, one or more engine sensors, one or more light and exhaust system sensors, one or more tire pressure sensors and one or more coolant sensors.

17. The system according to claim 14, wherein said vehicle is a used vehicle.

18. The system according to claim 17, wherein said Bluetooth system is exterior to said used vehicle.

19. The system according to claim 18, wherein said exterior Bluetooth system is in communication with a diagnostic port provided within said used vehicle.

20. The system according to claim 19, wherein said exterior Bluetooth system is in communication with said driver tag.
